(19) United States
(12) Patent Application Publication
(10) Pub. No.: US 2008/0091399 A1
(43) Pub. Date: Apr. 17, 2008

(54) Driverless signal generating apparatus and control method thereof

(75) Inventors: Bruce C. S. Chou, Hsin chu (TW); Jer-Wei Chang, Hsin Chu City (TW)

Correspondence Address: BIRCH STEWART KOLASCH & BIRCH, PO BOX 747, FALLS CHURCH, VA, 22040-0747, US

(73) Assignee: LIGHTUNING TECH, INC.

(21) Appl. No.: 11/907,696

(22) Filed: Oct. 16, 2007

(30) Foreign Application Priority Data
Oct. 17, 2006 (TW) 095138155

(51) Int. Cl. G06G 7/62

(52) U.S. Cl. 703/13

(57) ABSTRACT

A driverless signal generating apparatus to be connected to a computer host includes a signal generator and an interface controller, which is connected to the signal generator and has operation firmware stored therein. The operation firmware simulates the signal generating apparatus as a standard device. A driver corresponding to the standard device has been built in an operation system (OS) of the computer host. The operation firmware receives a first command outputted from the OS through the driver and makes the OS identify an attribute of the signal generating apparatus in response to the first command. An application program (AP) may be executed in the OS to generate a second command. The first and second commands pertain to a control transfer command for enabling control transfer. The firmware receives the second command and thus controls the signal generator to generate an external signal to be sent back to the OS.

### BACKGROUND OF THE INVENTION

1. Field of Invention

The invention relates to a driverless signal generating apparatus and a control method thereof, and more particularly to a control method of a driverless signal generating apparatus for controlling the signal generating apparatus to generate an external signal without installing a specific driver for the signal generating apparatus in an operation system (OS).

2. Related Art

A conventional user-machine interface apparatus or human interface device (HID), such as a keyboard or a mouse, is usually designed to have a plug-and-play function so that the user can easily use this apparatus. A driver for a USB human interface device has been built in an operation system (OS), such as “WINDOWS XP”. Thus, the user can use the user-machine interface apparatus, which may be identified by the OS of “WINDOWS XP” in a computer host, without additionally installing the driver.

The basic architecture of this user-machine interface apparatus includes a USB controller (or the controller with any other standard interface) and a human interface device, such as a keyboard, a mouse, or the like. The mouse and the keyboard pertain to the build-in function of the standard OS. That is, the drivers thereof have been built in the OS. If the USB controller of the user-machine interface apparatus is connected to the computer host, the computer host automatically installs the driver of the keyboard or mouse built in the OS. However, when an external signal generator, such as a fingerprint sensor, is connected to the computer host through the USB controller, the OS has no build-in driver for the fingerprint sensor. Therefore, the fingerprint sensor cannot be used when no specific driver is provided. So, the fingerprint sensor cannot be conveniently used and cannot be plugged and played. Furthermore, the driver has to be updated together with the updated OS of the computer in a very complicated manner. In addition, the manufacturer of the fingerprint sensor has to write the specific driver after the very complicated certification procedure has passed so that the OS, such as “WINDOWS XP” can recognize this device.

### SUMMARY OF THE INVENTION

It is therefore an object of the invention to provide a driverless signal generating apparatus and a control method thereof, wherein the signal generating apparatus can be controlled to generate an external signal without installing a specific driver for the signal generating apparatus in an operation system (OS).

The invention achieves the above-identified object by providing a driverless signal generating apparatus to be connected to a computer host having an operation system (OS), which has an application program (AP) for the signal generating apparatus. The signal generating apparatus includes a signal generator and an interface controller. The signal generator generates an external signal in response to external excitation. The interface controller is connected to the signal generator and is to be connected to the computer host, and has operation firmware stored in the interface controller. The operation firmware simulates the signal generating apparatus as a standard device. A driver corresponding to the standard device has been built in the OS so that the OS regards the signal generating apparatus as the standard device. The operation firmware receives a first command outputted from the OS through the driver and makes the OS identify an attribute of the signal generating apparatus in response to the first command. The AP may be executed in the OS to generate a second command. Each of the first command and the second command pertains to a control transfer command (CTC) for enabling control transfer. The operation firmware receives the second command and thus controls the signal generator to generate the external signal and to send the external signal back to the OS.

The invention also provides a control method of the driverless signal generating apparatus.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic illustration showing a computer host connected to a driverless signal generating apparatus according to a first embodiment of the invention;

FIG. 2 is a flow chart showing a control method of the driverless signal generating apparatus according to the first embodiment of the invention;

FIG. 3 is a schematic illustration showing a computer host connected to a driverless signal generating apparatus according to a second embodiment of the invention; and

FIG. 4 is a schematic illustration showing a computer host connected to a driverless signal generating apparatus according to a third embodiment of the invention.

### DETAILED DESCRIPTION OF THE INVENTION

The present invention will be apparent from the following detailed description, which proceeds with reference to the accompanying drawings, wherein the same references relate to the same elements.

When any USB device is connected to a computer host (e.g., when a USB thumb disk is inserted into the computer host, a driver of the OS of the computer host detects the existence of the USB thumb disk, and then outputs a control transfer command (CTC) to the USB thumb disk. Thus, the operation firmware of the USB thumb disk makes the OS identify the existence of the USB thumb disk and the attribute of this device (a USB storage device in this case) in response to the computer host, so that a storage device of the USB thumb disk may be accessed. Under the standard communication protocol, such as a bulk transfer command (BTC), the data in the USB thumb disk may be transferred to the computer host and executed therein.

Similarly, if the USB device is a keyboard or a mouse, the driver of the OS of the computer host detects the existence of the USB human interface device, and then outputs the CTC to the USB human interface device. Thus, the operation firmware of the USB human interface device makes the OS identify the existence of the USB human interface device and the device attribute thereof (a USB human interface device in this case) in response to the host so that a signal outputted from the USB human interface device may be read. Under the standard communication protocol, such as an interrupt transfer command (ITC), the input signal of the USB human interface device may be transferred to the computer host and executed therein.

According to the two examples mentioned hereinabove, it is found that the USB devices with different attributes have a common feature that the USB devices may be communicated with substantially the same CTC. The invention solves the above-mentioned problems according to this common CTC communication protocol. The invention adopts the CTC to command the signal generator, such as a fingerprint sensor, to get the signal and to transfer a lot of signal data, such as fingerprint image data. This may be done because the CTC is a communication protocol, which is common to any USB device, and may transfer a lot of data under the CTC communication protocol through suitable hardware and software designs. Consequently, any non-standard USB external signal generator corresponding to a driver which is not built in the OS may be simulated as a storage device, such as a BTC device, or a USB human interface device (ITC device), such as a keyboard or a mouse, corresponding to a driver built in the OS. In this case, the OS treats this signal generator as a standard known-device and uses the build-in driver to communicate with the device so that the driver transfers the signal generated by the external signal generator to the OS and the signal can be processed therein. According to this control method, no driver for the signal generator has to be certified and written so that the driverless signal generator can be obtained. In the following, the application and the method thereof will be described with reference to several embodiments.

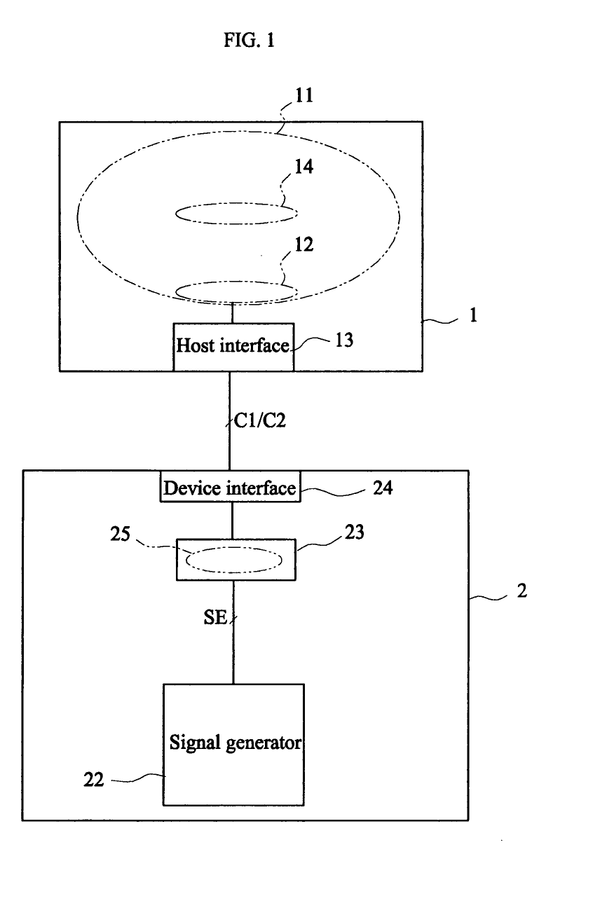

FIG. 1 is a schematic illustration showing a computer host connected to a driverless signal generating apparatus 2 according to a first embodiment of the invention. As shown in FIG. 1, the driverless signal generating apparatus 2 of this embodiment is to be connected to a computer host 1, which has a host interface 13 and an OS 11. The host interface 13 contains an interface controller. The OS 11 has a driver 12 and an AP 14 for the signal generating apparatus 2. The AP 14 may be installed in the OS 11 in advance, and the user may install the AP 14 in the OS 11 through an optical disk or the Internet.

The signal generating apparatus 2 includes a signal generator 22 and an interface controller 23. The signal generator 22 generates an external signal SE in response to external excitation. In this embodiment, the interface controller 23 is a USB controller. The interface controller 23 is connected to the signal generator 22 and is to be connected to the computer host 1. The interface controller 23 stores operation firmware 25. A device interface 24 of the signal generating apparatus 2 corresponds to the host interface 13, which is a USB interface in this embodiment and may be a PCI-Express interface, an IEEE 1394 interface, a SATA interface or any other standard interface in another embodiment. The signal generator 22 may be a biometrics sensor, such as a fingerprint sensor, a microphone, an optical image reader or a smart card reader or a subscriber identity module (SIM) card reader, or even a RF ID reader or any other known device. Similarly, each of the microphone and the optical image reader may serve as the biometrics sensor for sensing the user's biometrics data, such as the voice, iris, face and capillary. The smart card reader may read the smart card carried by the user.

In order to achieve the effect of the invention, the operation firmware 25 simulates the signal generating apparatus 2 as a standard device, and the driver 12 corresponding to the standard device has been built in the OS 11 so that the OS 11 regards the signal generating apparatus 2 as the standard device, such as a human interface device (HID) or a storage device. The HID may be a keyboard or a mouse. In addition, the operation firmware 25 receives a first command C1 outputted from the OS 11 through the driver 12, and makes the OS 11 identify an attribute of the signal generating apparatus 2 in response to the first command C1. Then, the AP 14 may be executed in the OS 11 to generate a second command C2. Each of the first command C1 and the second command C2 pertains to the CTC for enabling the control transfer. Finally, the operation firmware 25 receives the second command C2 and thus controls the signal generator 22 to generate the external signal SE and to send the external signal SE back to the OS 11.

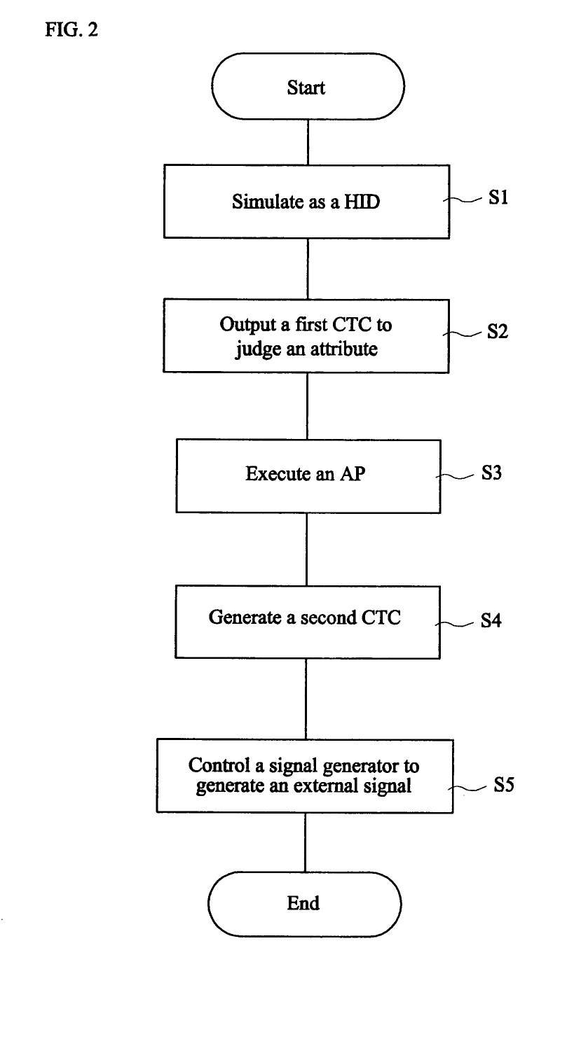

The operation firmware 25 and the AP 14 are configured to execute the steps S1 to S5, as shown in FIG. 2, after the signal generating apparatus 2 is connected to the computer host 1.

In step S1, the operation firmware 25 simulates the signal generating apparatus 2 as the standard device, such as the human interface device or the storage device, so that the OS 11 regards the signal generating apparatus 2 as the standard device.

In step S2, the operation firmware 25 receives the first command C1 outputted from the OS 11 through the build-in driver 12 for the human interface device or the storage device, and makes the OS 11 identify the attribute of the signal generating apparatus 2 in response to the first command C1.

Then, in step S3, the AP 14 is executed in the OS 11. The AP 14 may be executed by the user manually or may be executed automatically. In another embodiment, the AP may already be executed in the OS environment before the signal generating apparatus is connected to the computer host. At this condition, the AP keeps polling the existence of the signal generating apparatus 2.

Next, in step S4, the second command C2 is generated according to the executed AP 14.

Then, in step S5, the second command C2 is received to control the signal generator 22 of the signal generating apparatus 2 to generate the external signal SE and to send the external signal SE back to the OS 11 so that the subsequent process may be performed.

The maximum feature of the invention is to optimize the CTC communication according to the specific command architecture predefined in the AP and the operation firmware. Thus, the OS communicates with the signal generator 22 through the CTC. This may effectively overcome the restriction of the need of the specific driver.

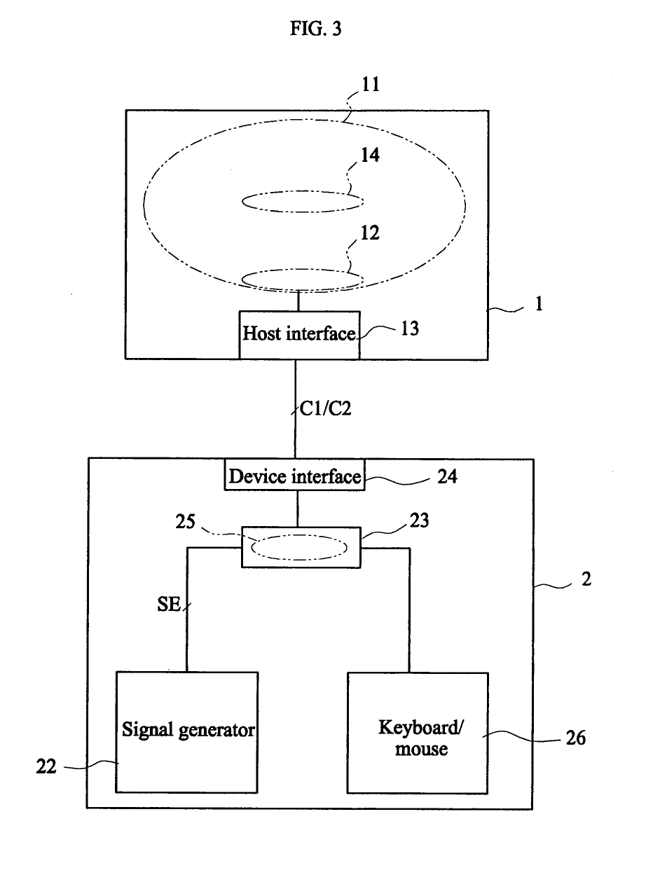

FIG. 3 is a schematic illustration showing a computer host connected to a driverless signal generating apparatus according to a second embodiment of the invention. As shown in FIG. 3, this embodiment is similar to the first embodiment except that the signal generating apparatus 2 of this embodiment further includes a keyboard or mouse 26, which is connected to the interface controller 23 and outputs a signal to control the operation of the OS 11. In this embodiment, the OS 11 also regards the signal generating apparatus 2 as the human interface device according to the design of the operation firmware 25 of the interface controller 23. So, the signal generating apparatus 2 also does not need the additionally provided driver.

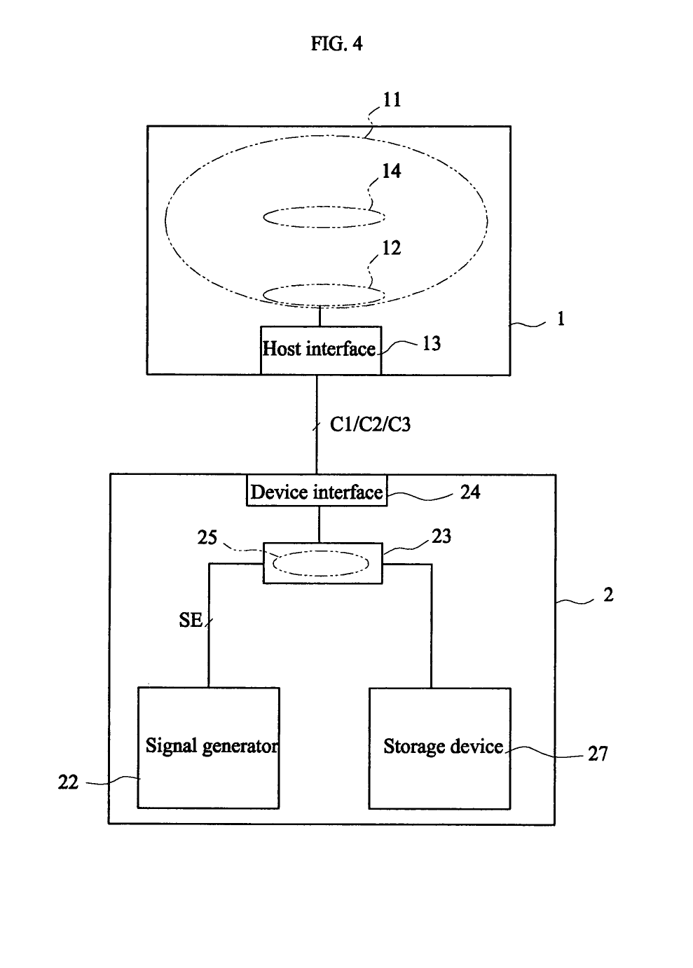

FIG. 4 is a schematic illustration showing a computer host connected to a driverless signal generating apparatus according to a third embodiment of the invention. As shown in FIG. 4, the signal generating apparatus 2 of this embodiment is similar to that of the first embodiment, but further includes a storage device 27 connected to the interface controller 23. The storage device may be a flash memory or any other non-volatile memory for storing data, such as template fingerprint data or private data, which may come from the signal generator 22 or the computer host 1. In this embodiment, the OS 11 controls the storage device 27 through a third command C3 pertaining to the CTC. Similarly, the signal generating apparatus 2 also does not need the additionally provided driver. It is to be noted that the number of each of the commands C1, C2 and C3 is not restricted to one in the overall operation state. Instead, many commands may be used to make the overall system work normally. For example, when a plurality of third commands C3 is used to control the storage device 27, two commands for reading and writing the storage device may be used.

According to the embodiments of the invention, it is possible to obtain the signal generating function of the signal generating apparatus without the need of the specific driver so that the complicated driver certification procedure has to be performed. Because the AP does not need to be certified, the procedure of writing the AP can be simplified.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. A driverless signal generating apparatus to be connected to a computer host, which has an operation system (OS) having an application program (AP) for the signal generating apparatus, the signal generating apparatus comprising:
a signal generator for generating an external signal in response to external excitation; and
an interface controller, which is connected to the signal generator and is to be connected to the computer host, and has operation firmware stored in the interface controller, wherein:
the operation firmware simulates the signal generating apparatus as a standard device, wherein a driver corresponding to the standard device has been built in the OS so that the OS regards the signal generating apparatus as the standard device;
the operation firmware receives a first command outputted from the OS through the driver and makes the OS identify an attribute of the signal generating apparatus in response to the first command;
the AP may be executed in the OS to generate a second command, wherein each of the first command and the second command pertains to a control transfer command (CTC) for enabling control transfer; and
the operation firmware receives the second command and thus controls the signal generator to generate the external signal and to send the external signal back to the OS.

2. The apparatus according to claim 1, wherein the signal generator is a biometrics sensor.

3. The apparatus according to claim 1, wherein the signal generator is a fingerprint sensor, a microphone, an optical image reader, a smart card reader or a subscriber identity module (SIM) card reader.

4. The apparatus according to claim 1, wherein the interface controller is a universal serial bus (USB) controller.

5. The apparatus according to claim 1, wherein the standard device is a keyboard or a mouse.

6. The apparatus according to claim 1, further comprising a keyboard or a mouse, connected to the interface controller, for outputting a signal to control the OS to operate.

7. The apparatus according to claim 1, further comprising a storage device, connected to the interface controller, for storing data.

8. The apparatus according to claim 7, wherein the data comes from the signal generator or the computer host.

9. The apparatus according to claim 7, wherein the OS controls the storage device through a third command pertaining to the CTC.

10. The apparatus according to claim 9, wherein the third command is a command for reading or writing the storage device.

11. The apparatus according to claim 7, wherein the storage device is a flash memory or a non-volatile memory.

12. A control method for a driverless signal generating apparatus to be connected to a computer host having an operation system (OS), which has an application program (AP) for the signal generating apparatus, the control method comprising the steps of:
simulating the signal generating apparatus as a standard device, wherein a driver corresponding to the standard device has been built in the OS so that the OS regards the signal generating apparatus as the standard device;
receiving a first command outputted from the OS through the driver and enabling the OS to identify an attribute of the signal generating apparatus in response to the first command;
executing the AP to generate a second command, wherein each of the first command and the second command pertains to a control transfer command (CTC) for enabling control transfer; and
receiving the second command and thus controlling the signal generating apparatus to receive external excitation to generate an external signal, and to send the external signal back to the OS.

13. The method according to claim 12, wherein the external signal comprises biometrics data.
